(19) United States
(12) Patent Application Publication
(10) Pub. No.: US 2026/0063450 A1
(43) Pub. Date: Mar. 5, 2026

(54) SUSPENSION STRUCTURE, AND DETECTION MODULE AND MICRO-DISPLACEMENT DETECTION DEVICE COMPRISING THE SAME

(71) Applicants: SHANGHAI INSTITUTE OF MEASUREMENT AND TESTING TECHNOLOGY, Shanghai (CN); SHANGHAI JICE INFORMATION TECHNOLOGY CO., LTD., Shanghai (CN)

(72) Inventors: Junjie WU, Shanghai (CN); Jiasi WEI, Shanghai (CN); Xiaoyu CAI, Shanghai (CN); Yuan LI, Shanghai (CN); Yong ZHOU, Shanghai (CN); Kaixin SUN, Shanghai (CN)

(73) Assignees: SHANGHAI INSTITUTE OF MEASUREMENT AND TESTING TECHNOLOGY, Shanghai (CN); SHANGHAI JICE INFORMATION TECHNOLOGY CO., LTD., Shanghai (CN)

(21) Appl. No.: 19/202,193

(22) Filed: May 8, 2025

Related U.S. Application Data
(63) Continuation of application No. PCT/CN2025/078494, filed on Feb. 21, 2025.

(30) Foreign Application Priority Data
Aug. 29, 2024 (CN) 202411197644.4

(51) Int. Cl. G01D 11/02; G01B 21/02; G01D 11/16; G01D 11/30

(52) U.S. Cl. CPC G01D 11/02; G01B 21/02; G01D 11/16; G01D 11/30

(57) ABSTRACT

The present disclosure provides a suspension structure, and a detection module and a micro-displacement detection device comprising the same. The suspension structure comprises a central region, a fixing frame, and a plurality of suspension beams. The central region is circular and configured to fix an upper end of a probe. The fixing frame is provided around the central region. An inner edge of the fixing frame is circular and coaxial with the central region. The fixing frame is configured to fix to a clamping assembly. The plurality of suspension beams are provided between the central region and the fixing frame. Two ends of each of the plurality of suspension beams are connected with an outer edge of the central region and the inner edge of the fixing frame, respectively. The plurality of suspension beams are uniformly distributed in a circumferential direction of the central region.

### CROSS-REFERENCE TO RELATED APPLICATIONS

This application is a continuation of International Application No. PCT/CN2025/078494, filed on Feb. 21, 2025, which claims priority to Chinese Patent Application No. 202411197644.4, filed on Aug. 29, 2024, the entire contents of each of which are incorporated herein by reference.

### TECHNICAL FIELD

The present disclosure relates to a suspension structure, and a detection module and a micro-displacement detection device comprising the same.

### BACKGROUND

Currently, common measurement techniques for micro-nano scale 3D measurement include scanning probe microscopy (SPM), confocal microscopy, white light interferometry, and a micro-nano coordinate measuring machine (CMM). The micro-nano coordinate measuring machine demonstrates advantages in resolving the inherent trade-off between measurement range and accuracy. It integrates 3D probing and sensing capabilities, achieving the true 3D measurement. This approach currently represents one of the most effective solutions for addressing 3D measurement challenges at the micro-nano scale.

In the micro-nano coordinate measurement, the probe features a probe tip that contacts the sample surface. As the sample moves, the probe tip follows surface topographical variations, resulting in corresponding displacements. The displacements of the probe tip can be calculated using a detector, so as to obtain surface topography data and 3D measurements of critical dimensions. To ensure the measurement accuracy, the probe must maintain vertical alignment when free from external forces, while permitting unrestricted probe movement to track the surface variations without interference.

A key technical challenge in the micro-nano coordinate metrology involves maintaining vertical alignment of the probe when free from external forces while permitting unrestricted probe movement to track the surface variations without interference.

### SUMMARY

In order to ensure that the probe maintains vertical alignment when free from external forces, while permitting unrestricted probe movement to track the surface variations without interference, the present disclosure provides a suspension structure, and a detection module and a micro-displacement detection device comprising the same.

The present disclosure solves the above technical problem by the following technical solution.

The present disclosure provides a suspension structure, configured to suspend a probe. The suspension structure may comprise a central region, a fixing frame, and a plurality of suspension beams. The central region may be circular and configured to fix an upper end of the probe. The fixing frame may be provided around the central region. An inner edge of the fixing frame may be circular, the inner edge of the fixing frame may be coaxial with the central region, and the fixing frame may be configured to fix to a clamping assembly. The plurality of suspension beams may be provided between the central region and the fixing frame. Two ends of each of the plurality of suspension beams may be connected with an outer edge of the central region and the inner edge of the fixing frame, respectively. The plurality of suspension beams may be uniformly distributed in a circumferential direction of the central region.

In the present technical solution, since the plurality of suspension beams are uniformly distributed in the circumferential direction of the central region, the probe is subjected to a uniform force, such that the probe maintains a vertical state when free from external forces, while permitting unrestricted probe movement to track the surface variations without interference.

Preferably, a centerline of each of the plurality of suspension beams may be an Archimedean spiral, and a polar coordinate origin of the centerline may coincide with a center of the central region.

In the present technical solution, the plurality of suspension beams extending in the direction of the Archimedean spiral make the probe be subjected to a uniform force, maintaining the probe in a vertical state when free from external forces. In addition, the probe can maintain sufficient rigidity to drive the reflector assembly to move by tracking the surface variations of the sample surface.

Preferably, a radius of the inner edge of the fixing frame may be 0.6 mm, a radius of the outer edge of the central region may be 2.6 mm; and a polar equation of the centerline of each of the plurality of suspension beams may denoted as

$$r = a + b θ , a = 0.6 mm , b = \frac{1}{180} mm / ° .$$

In the present technical solution, the suspension structure provided according to the above dimensions allows the probe to maintain sufficient rigidity to drive the reflector assembly to move by tracking the surface variations of the sample surface.

Preferably, 3-6 suspension beams may be provided.

In the present technical solution, the 3-6 suspension beams can ensure the strength of the suspension structure without interfering the displacement of the probe tip following the surface variations of the sample surface.

Preferably, the suspension structure may be made of a beryllium copper or silicon material.

In the present technical solution, the suspension structure made of the beryllium copper or silicon material achieves isotropic detection stiffness of the probe tip during transverse and longitudinal detection.

The present disclosure further provides a detection module. The detection module may comprise the suspension structure described above, a clamping assembly, and a probe. The clamping assembly may be configured to fix the fixing frame of the suspension structure to make the suspension structure horizontally arranged. The clamping assembly may be further configured to fix to a connection module. An upper end of the probe may be fixed to a lower surface of the central region of the suspension structure to cause the probe to be in a suspended state.

In the present technical solution, the entire detection module can be fixed to the mounting table of the micro-displacement detection device using the clamping assembly, thereby ensuring that the suspension structure is horizontally arranged.

Preferably, the clamping assembly may be provided around the suspension structure to enclose the central region and the plurality of suspension beams of the suspension structure.

In the present technical solution, the clamping assembly is provided around the suspension structure to enclose the central region and the plurality of suspension beams of the suspension structure, which ensures that the suspension structure is subjected to a uniform force.

Preferably, the clamping assembly may include a lower base, an upper pressure plate, and a clamping member. An upper surface of the lower base may be provided with a placing surface, and a lower surface of the fixing frame of the suspension structure may be placed on the placing surface of the lower base. The upper pressure plate may be configured to be pressed against an upper surface of the fixing frame of the suspension structure. The clamping member may be configured to clamp the upper pressure plate and the lower base to clamp the fixing frame of the suspension structure between the lower base and the upper pressure plate.

In the present technical solution, by clamping the fixing frame of the suspension structure using the lower base and the upper pressure plate, and then clamping the upper pressure plate and the lower base using the clamping member, the suspension structure can be fixed in a horizontal state.

Preferably, the lower base may be provided with an upward convex boss, and the placing surface may be formed on an upper surface of the upward convex boss.

In the present technical solution, the suspension structure is placed on the upward convex boss during mounting, and the upward convex boss plays a role in positioning the suspension structure; meanwhile, the upward convex boss also facilitates the design and mounting of the clamping member, such that the clamping member can realize the function of clamping the lower base and the upper pressure plate.

Preferably, the lower base may be provided with an outward extending flange. The outward extending flange may be configured to fix to a mounting table.

In the present technical solution, the clamping assembly is fixed to the mounting table by the outward extending flange such that the entire detection module is fixed to the micro-displacement detection device.

Preferably, the clamping member may include a clamping body, an upper pressure edge, and a lower fixing edge. The upper pressure edge may be provided on an upper edge of the clamping body and pressed against an upper surface of the upper pressure plate. The lower fixing edge may be provided on a lower edge of the clamping body and fixed to the lower base.

In the present technical solution, the clamping member of the above structure, by the lower fixing edge being fixed to the lower base, makes the upper pressure edge press the upper pressure plate, so as to press and fix the suspension structure.

Preferably, the upper surface of the upper pressure plate may be provided with a downward concave accommodation groove, and the upper pressure edge may be disposed in the downward concave accommodation groove.

In the present technical solution, the downward concave accommodation groove may be configured to position the upper pressure edge, so as to fix the position of the clamping member relative to the position of the upper pressure plate during mounting.

Preferably, a plurality of clamping members may be provided, and the plurality of clamping members may be disposed around the suspension structure.

In the present technical solution, the plurality of clamping members are disposed around the suspension structure, such that the suspension structure is subjected to a uniform force to ensure that the probe always maintains in the middle position.

Preferably, the detection module may further include a reflector assembly. A lower end of the reflector assembly may be fixed to an upper surface of the central region of the suspension structure.

In the present technical solution, a reflector body is disposed at an upper end of the reflector assembly, such that the displacement of the probe tip of the probe can be calculated by detecting the displacement of the reflector body.

The present disclosure further provides a micro-displacement detection device. The micro-displacement detection device may comprise the detection module described above, a connection module, and a mounting table. The connection module may be configured to be fixed to the clamping assembly of the detection module to make the suspension structure horizontally arranged. The connection module may be fixed to the mounting table. The mounting table may be further configured to be fixed to a measurement platform.

In the present technical solution, when the detection module is mounted on the micro-displacement detection device, the connection module is fixed to the clamping assembly of the detection module to make the suspension structure horizontally arranged; and the connection module is fixed to the mounting table, and the mounting table is further configured to be fixed to the measurement platform.

Preferably, the detection module may further include a reflector assembly. A lower end of the reflector assembly may be fixed to an upper surface of a central region of the suspension structure, and an upper end of the reflector assembly may be provided with a reflector body. The micro-displacement detection device may further comprise at least one detector. The at least one detector may be disposed on the mounting table and configured to detect displacement of the reflector body.

In the present technical solution, the at least one detector is configured to detect the displacement of the reflector body of the reflector assembly, and the displacement of the probe tip of the probe is calculated based on the displacement of the reflector body, thereby obtaining the topography data of the sample surface and the 3D measurements of critical dimensions.

The above preferred conditions can be arbitrarily combined to obtain the preferred embodiments of the present disclosure on the basis of conforming to the common knowledge in the field.

The positive progressive effects of the present disclosure include the following content.

According to the suspension structure, and the detection module and the micro-displacement detection device comprising the same, the suspension structure configured to suspend the probe is connected to the central region by the plurality of suspension beams uniformly distributed in the circumferential direction, such that the probe fixed to the central region is subjected to a uniform force, and the probe can maintain a vertical state when free from external forces while permitting unrestricted probe movement to track the surface variations of the sample surface without interference, thereby ensuring the accuracy and stability of the sample measurement.

### BRIEF DESCRIPTION OF THE DRAWINGS

FIG. 1 is a schematic structural diagram illustrating a micro-displacement detection device of the present disclosure.

FIG. 2 is a schematic structural diagram illustrating a partial enlargement of a region A of the micro-displacement detection device shown in FIG. 1.

FIG. 3 is a schematic structural diagram illustrating a suspension structure of the present disclosure.

FIG. 4 is a top view of the suspension structure shown in FIG. 3.

FIG. 5 is a schematic diagram illustrating assembly of the suspension structure shown in FIG. 3 with a probe and a reflector assembly.

FIG. 6 is a schematic structural diagram illustrating a detection module of the present disclosure.

FIG. 7 is a schematic diagram illustrating a cross section of the detection module shown in FIG. 6.

FIG. 8 is a schematic diagram illustrating assembly of the detection module shown in FIG. 6 and a connection module.

### DESCRIPTION OF REFERENCE SIGNS

Detection module 100, suspension structure 1, central region 11, outer edge 111, fixing frame 12, inner edge 121, suspension beam 13, centerline 131, probe 2, probe tip 21, reflector assembly 3, reflector body 31, clamping assembly 4, lower base 41, placing surface 411, boss 412, flange 413, mounting hole 414, upper pressure plate 42, accommodation groove 421, clamping member 43, clamping body 431, upper pressure edge 432, lower fixing edge 433, detector 200, connection module 300, mounting table 400.

### DETAILED DESCRIPTION

The present disclosure is further illustrated below by way of embodiments, but does not therefore limit the present disclosure to the scope of the described embodiments.

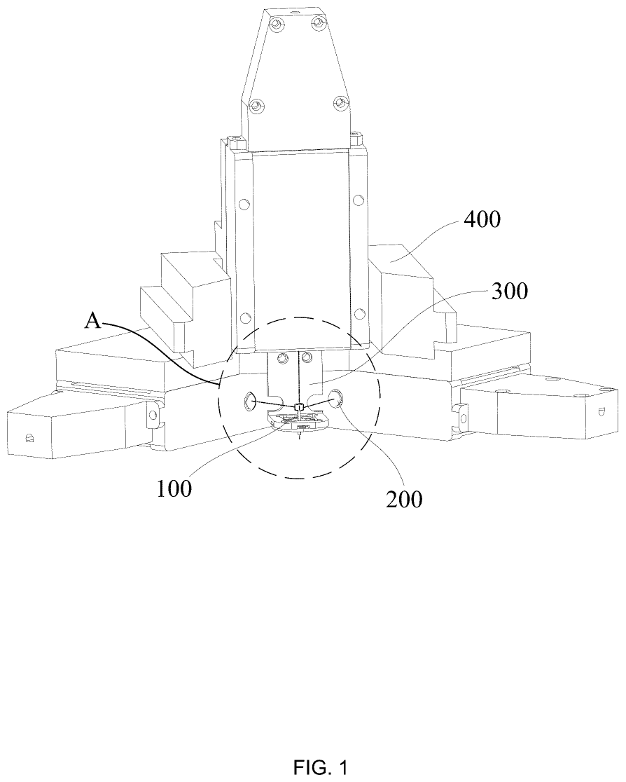

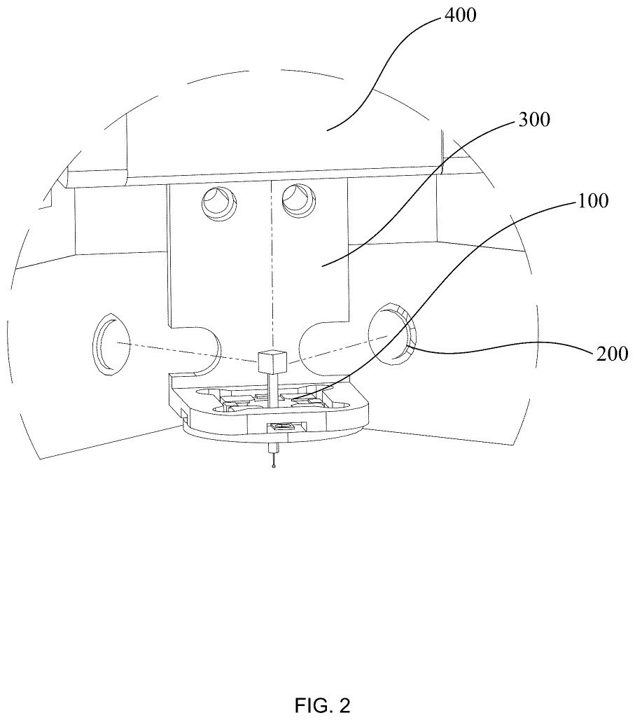

FIG. 1 and FIG. 2 illustrate a micro-displacement detection device. A detection module 100 of the micro-displacement detection device may be provided with a probe 2 fixed to a lower surface of a suspension structure 1 and a reflector assembly 3 fixed to an upper surface of the suspension structure 1. A probe tip 21 may be formed at a lower end of the probe 2. The probe tip 21 may be configured to contact a sample surface and undergo displacement by following surface topographical variations as the sample moves. A reflector body 31 may be provided at an upper end of the reflector assembly 3, and the reflector body 31 of the reflector assembly 3 may move as the probe tip 21 moves, such that the displacement of the probe tip 21 may be converted into displacement of the reflector body 31. The detection device may further include a plurality of detectors 200. The detectors 200 may be configured to detect the displacement of the reflector body 31, so as to calculate the displacement of the probe tip 21, obtain the morphology data of the sample surface, and the 3D measurements of critical dimensions.

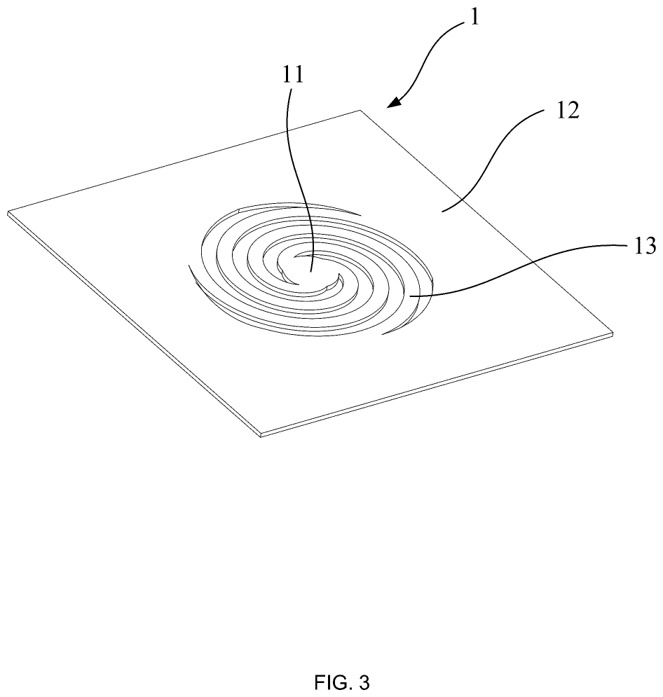

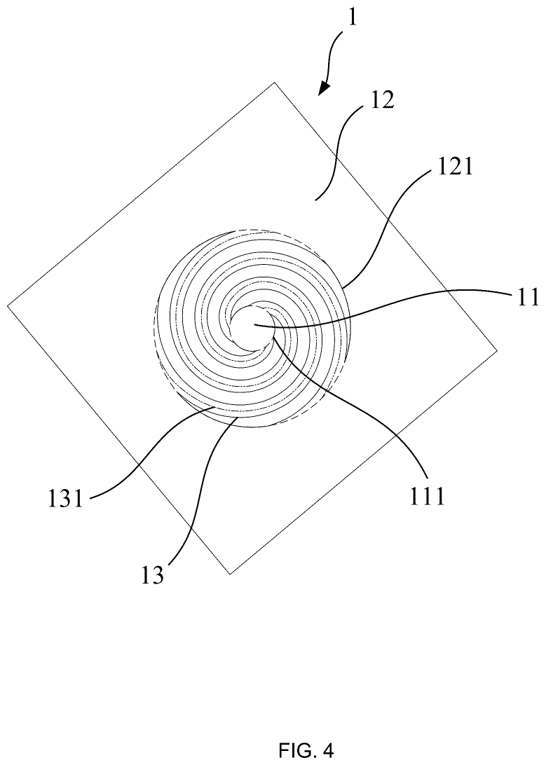

In order to ensure that the probe 2 maintains in a vertical state when free from external forces while permitting displacement of the probe tip 21 to track the surface variations of the sample surface without interference, the structure of the suspension structure 1 is as shown in FIGS. 3-4. The suspension structure 1 may include a central region 11, a fixing frame 12, and a plurality of suspension beams 13. The central region 11 may be circular. The fixing frame 12 may be provided around the central region 11, an inner edge 121 of the fixing frame 12 may be circular, and the inner edge 121 of the fixing frame 12 may be coaxial with the central region 11. The plurality of suspension beams 13 may be provided between the central region 11 and the fixing frame 12. Two ends of each of the plurality of suspension beams 13 may be connected with an outer edge 111 of the central region 11 and the inner edge 121 of the fixing frame 12. The plurality of suspension beams 13 may be uniformly distributed in a circumferential direction of the central region 11.

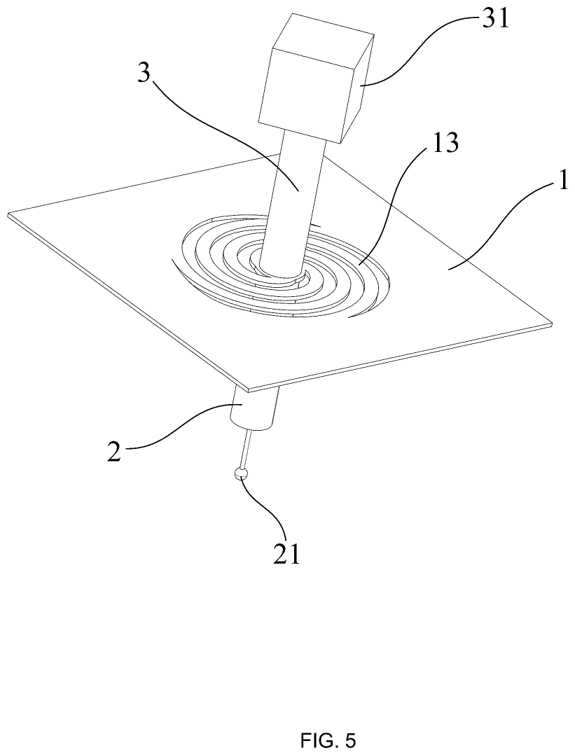

As shown in FIG. 5, the probe 2 may be fixed to a lower surface of the central region 11. Since the plurality of suspension beams 13 are uniformly distributed in the circumferential direction of the central region 11, the probe 2 is subjected to a uniform force, and the probe 2 maintains in a vertical state when free from external forces while permitting the displacement of the probe tip 21 to track the surface variations of the sample surface without interference.

The reflector assembly 3 may be fixed to an upper surface of the central region 11. When the probe tip 21 moves, the probe 2 may rotate, and the central region 11 of the suspension structure 1 may rotate together with the probe 2. As the reflector assembly 3 is fixed to the upper surface of the central region 11, the reflector assembly 3 may also rotate with the probe 2, such that the displacement of the probe tip 21 can be converted into the displacement of the reflector body 31 of the reflector assembly 3.

In order to ensure the symmetry of the displacements of the probe tip 21 and the reflector body 31, the probe 2 and the reflector assembly 3 may be coaxial with the central region 11 of the suspension structure 1.

As shown in FIGS. 3-4, a centerline 131 of each of the plurality of suspension beams 13 may be an Archimedean spiral, and a polar coordinate origin of the centerline 131 may coincide with a center of the central region 11. The suspension beams 13, which extend in the direction of the Archimedean spiral, allow the probe 2 to be subjected to a uniform force and maintain in a vertical state when free from external forces. Meanwhile, the probe tip 21 can remain sufficient sensitivity to undergo the displacement by following the surface variations of the sample surface.

A radius of the inner edge 121 of the fixing frame 12 may be 2.6 mm, and a radius of the outer edge 111 of the central region 11 may be 0.6 mm. A polar equation of the centerline 131 of each of the suspension beams 13 may be denoted as

$$r = a + b θ , a = 0.6 mm , b = \frac{1}{180} mm / ° .$$

The suspension structure 1 with the above dimensional settings makes the probe tip 21 of the probe 2 remain sufficient sensitivity to undergo the displacement by following the surface variations of the sample surface.

In this embodiment, the centerline 131 of each of the suspension beams 13 may be the Archimedean spiral. In other embodiments, the centerline 131 of each of the suspension beams 13 may be other shapes that achieve uniform force on the probe 2.

In this embodiment, three suspension beams 13 are provided. The three suspension beams 13 may be uniformly distributed in the circumferential direction of the central region 11, such that the probe 2 fixed below the central region 11 is subjected to a uniform force. In other embodiments, 3-6 suspension beams 13 may be provided. The 3-6 suspension beams 13 can ensure the strength of the suspension structure 1 while permitting the displacement of the probe tip 21 by following the surface variations of the sample surface.

In this embodiment, the suspension structure 1 is made of a beryllium copper or silicon material. The suspension structure 1 made of the beryllium copper or silicon material can achieve isotropic stiffness during transverse and longitudinal detection.

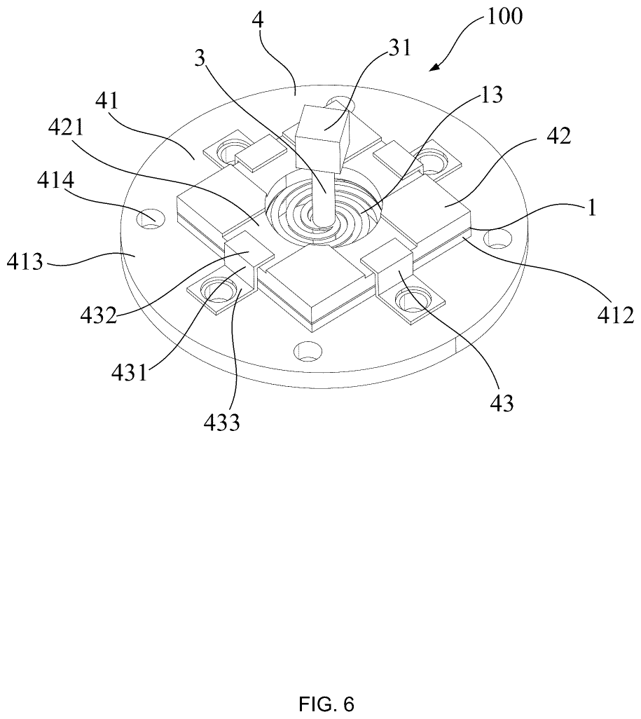

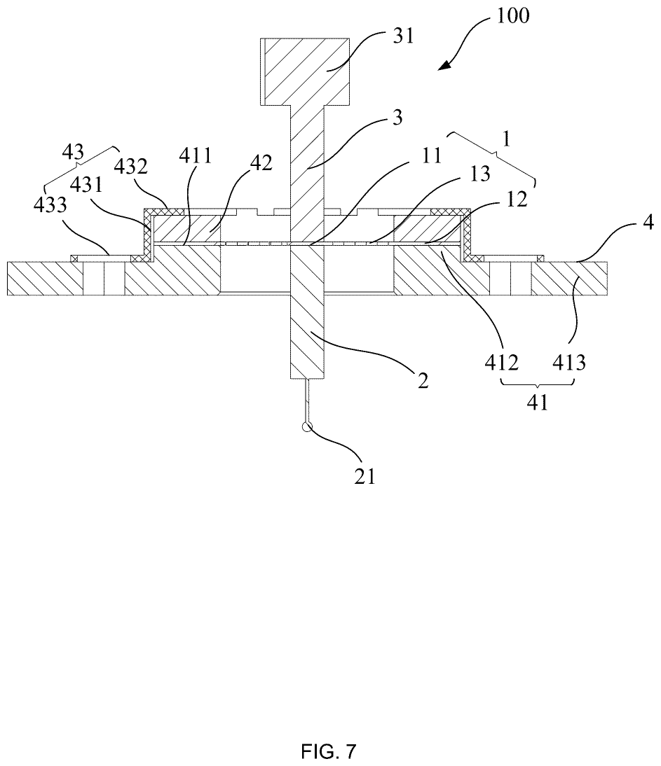

The suspension structure 1 may be mounted on the detection module 100, as shown in FIGS. 6-7. The detection module 100 may include the suspension structure 1, a clamping assembly 4, and the probe 2. The clamping assembly 4 may be configured to fix the fixing frame 12 of the suspension structure 1, such that the suspension structure 1 is horizontally arranged. An upper end of the probe 2 may be fixed to the lower surface of the central region 11 of the suspension structure 1, such that the probe 2 is in a suspended state. The entire detection module 100 can be fixed to a mounting table 400 of the micro-displacement detection device by the clamping assembly 4.

The probe 2 may be fixed to the lower surface of the central region 11, and the probe tip 21 of the probe 2 may undergo the displacement by following the surface variations of the sample surface. The reflector assembly 3 may be fixed to the upper surface of the central region 11. When the probe tip 21 of the probe 2 moves, the probe 2 may rotate, and the central region 11 of the suspension structure 1, and the reflector assembly 3 may rotate with the probe 2, such that the displacement of the probe tip 21 can be converted into the displacement of the reflecting body 31 of the reflector assembly 3.

In order to ensure that the suspension structure 1 is subjected to a uniform force, the clamping assembly 4 may be provided around the suspension structure 1 to enclose the central region 11 and the suspension beams 13 of the suspension structure 1.

As shown in FIGS. 6-7, the clamping assembly 4 may include a lower base 41, an upper pressure plate 42, and a clamping member 43. An upper surface of the lower base 41 may be provided with a placing surface 411, and the lower surface of the fixing frame 12 of the suspension structure 1 may be placed on the placing surface 411 of the lower base 41. The upper pressure plate 42 may be pressed on the upper surface of the fixing frame 12 of the suspension structure 1. The clamping member 43 may clamp the upper pressure plate 42 and the lower base 41 such that the fixing frame 12 of the suspension structure 1 is clamped between the lower base 41 and the upper pressure plate 42.

By clamping the fixing frame 12 of the suspension structure 1 by the lower base 41 and the upper pressure plate 42, and then clamping the upper pressure plate 42 and the lower base 41 using the clamping member 43, the suspension structure 1 can be fixed in a horizontally unfolded state.

The lower base 41 may be provided with an upward convex boss 412, and the placing surface 411 may be formed on an upper surface of the upward convex boss 412. The suspension structure 1 may be placed on the upward convex boss 412 during mounting, such that the upward convex boss 412 serves to position the suspension structure 1. Meanwhile, the upward convex boss 412 facilitates the design and mounting of the clamping member 43, such that the clamping member 43 can realize the function of clamping the lower base 41 and the upper pressure plate 42.

The boss 412, the upper pressure plate 42, and the fixing frame 12 of the suspension structure 1 may have the same shape, such that the boss 412, the suspension structure 1, and the upper pressure plate 42 may be integrated after being stacked, which facilitates the mounting of the clamping member 43; meanwhile, the central region 11 of the suspension structure 1 and the suspension beams 13 may be enclosed between the upper pressure plate 42 and the boss 412.

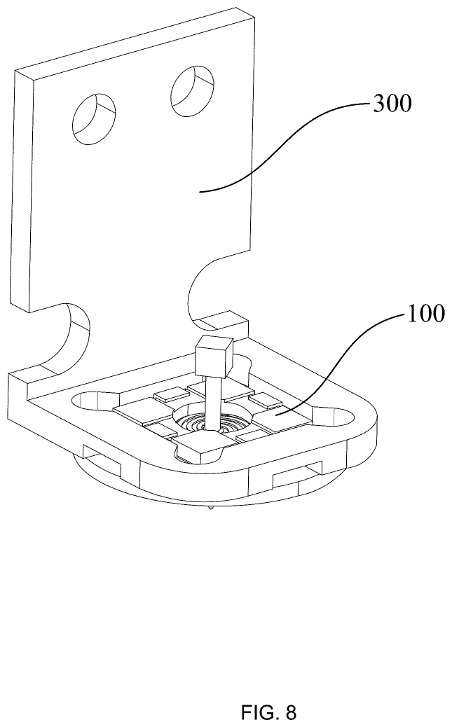

As shown in FIG. 6, the lower base 41 may be provided with an outward extending flange 413, and the clamping assembly 4 may be to the mounting table 400 of the micro-displacement detection device by the outward extending flange 413. In this embodiment, the outward extending flange 413 is provided with a plurality of mounting holes 414. As shown in FIG. 8, the lower base 41 may be fixed to the connection module 300 by fixing bolts penetrating through the mounting holes 414, and then the detection module 100 may be fixed to the mounting table 400 by fixing the connection module 300 to the mounting table 400.

As shown in FIGS. 6-7, the clamping member 43 may include a clamping body 431, an upper pressure edge 432, and a lower fixing edge 433. The upper pressure edge 432 may be formed on an upper edge of the clamping body 431, and the upper pressure edge 432 may be pressed on an upper surface of the upper pressure plate 42. The lower fixing edge 433 may be formed on a lower edge of the clamping body 431, and the lower fixing edge 433 may be fixed to the lower base 41. According to the clamping member 43 of the above structure, the lower fixing edge 433 is fixed to the lower base 41, such that the upper pressure edge 432 can press against the upper pressure plate 42 so as to press and fix the suspension structure 1.

The upper surface of the upper pressure plate 42 may be provided with a downward concave accommodation groove 421, and the upper pressure edge 432 may be disposed in the downward concave accommodation groove 421. The downward concave accommodation groove 421 may be configured to position the upper pressure edge 432 such that the position of the clamping member 43 is fixed relative to the position of the upper pressure plate 42 during mounting.

In this embodiment, a shape of the upper pressure plate 42 and the boss 412 is a square, respectively; correspondingly, four clamping members 43 are provided, and the four clamping members 43 are respectively disposed on four sides of the upper pressure plate 42, such that the suspension structure 1 clamped between the upper pressure plate 42 and the boss 412 can be subjected to a uniform force. In other embodiments, the shape of the upper pressure plate 42 and the boss 412, and the count and the position of the clamping member 43 may be provided based on actual needs. A plurality of clamping members 43 may be provided by priority, and the plurality of clamping members 43 may be provided around the suspension structure 1, such that the suspension structure 1 is subjected to a uniform force, ensuring that the probe 2 always maintains the position in the middle.

As shown in FIG. 1, FIG. 2, and FIG. 8, when the detection module 100 is mounted on the micro-displacement detection device, the connection module 300 may be fixed to the clamping assembly 4 of the detection module 100 to make the suspension structure 1 horizontally arranged; the connection module 300 may be fixed to the mounting table 400, and the mounting table 400 may be further configured to be fixed to a measurement platform.

The micro-displacement detection device may further include at least one detector 200. The at least one detector may be disposed on the mounting table 400 and configured to detect the displacement of the reflector body 31 of the reflector assembly 3. In this embodiment, the reflector body 31 is a cube; three detectors 200 are provided and configured to detect the displacement of the reflector body 31 from X, Y, and Z directions, respectively. In other embodiments, the shape of the reflector body 31, and the count and direction of the at least one detector 200 may be provided based on actual needs.

The present disclosure is not limited to the above embodiments, and any changes made in its shape or structure fall within the scope of protection of the present disclosure. The scope of protection of the present disclosure is defined by the appended claims, and those skilled in the art may make various changes or modifications to these embodiments without departing from the principles and substance of the present disclosure. However, these changes and modifications fall within the scope of protection of the present disclosure.

What is claimed is:

1. A suspension structure, configured to suspend a probe, comprising:
a central region being circular and configured to fix an upper end of the probe;
a fixing frame provided around the central region, wherein an inner edge of the fixing frame is circular, the inner edge of the fixing frame is coaxial with the central region, and the fixing frame is configured to fix to a clamping assembly; and
a plurality of suspension beams, wherein the plurality of suspension beams are provided between the central region and the fixing frame, and two ends of each of the plurality of suspension beams are connected with an outer edge of the central region and the inner edge of the fixing frame, respectively; the plurality of suspension beams being uniformly distributed in a circumferential direction of the central region.

2. The suspension structure of claim 1, wherein a centerline of each of the plurality of suspension beams is an Archimedean spiral, and a polar coordinate origin of the centerline coincides with a center of the central region.

3. The suspension structure of claim 2, wherein a radius of the inner edge of the fixing frame is 0.6 mm, a radius of the outer edge of the central region is 2.6 mm; and a polar equation of the centerline of each of the plurality of suspension beams is denoted as
$$r = a + b θ , a = 0.6 mm , b = \frac{1}{180} mm / ° .$$

4. The suspension structure of claim 1, wherein 3-6 suspension beams are provided.

5. The suspension structure of claim 1, wherein the suspension structure is made of a beryllium copper or silicon material.

6. A detection module, comprising:
the suspension structure of claim 1;
a clamping assembly configured to fix the fixing frame of the suspension structure to make the suspension structure horizontally arranged; the clamping assembly being further configured to fix to a connection module; and
a probe, wherein an upper end of the probe is fixed to a lower surface of the central region of the suspension structure to cause the probe to be in a suspended state.

7. The detection module of claim 6, wherein the clamping assembly is provided around the suspension structure to enclose the central region and the plurality of suspension beams of the suspension structure.

8. The detection module of claim 6, wherein the clamping assembly includes:
a lower base, an upper surface of the lower base being provided with a placing surface, and a lower surface of the fixing frame of the suspension structure being placed on the placing surface of the lower base;
an upper pressure plate configured to be pressed against an upper surface of the fixing frame of the suspension structure; and
a clamping member configured to clamp the upper pressure plate and the lower base to clamp the fixing frame of the suspension structure between the lower base and the upper pressure plate.

9. The detection module of claim 8, wherein the lower base is provided with an upward convex boss, the placing surface being formed on an upper surface of the upward convex boss.

10. The detection module of claim 8, wherein the lower base is provided with an outward extending flange, the outward extending flange being configured to fix to a mounting table.

11. The detection module of claim 8, wherein the clamping member includes:
a clamping body;
an upper pressure edge provided on an upper edge of the clamping body and pressed against an upper surface of the upper pressure plate; and
a lower fixing edge provided on a lower edge of the clamping body and fixed to the lower base.

12. The detection module of claim 11, wherein the upper surface of the upper pressure plate is provided with a downward concave accommodation groove, the upper pressure edge being disposed in the downward concave accommodation groove.

13. The detection module of claim 8, a plurality of clamping members are provided, and the plurality of clamping members are disposed around the suspension structure.

14. The detection module of claim 6, wherein the detection module further includes a reflector assembly, a lower end of the reflector assembly being fixed to an upper surface of the central region of the suspension structure.

15. A micro-displacement detection device, comprising:
the detection module of claim 6;
a connection module configured to be fixed to the clamping assembly of the detection module to make the suspension structure horizontally arranged; and
a mounting table, wherein the connection module is fixed to the mounting table, and the mounting table is further configured to be fixed to a measurement platform.

16. The micro-displacement detection device of claim 15, wherein the detection module further includes a reflector assembly, a lower end of the reflector assembly is fixed to an upper surface of a central region of the suspension structure, an upper end of the reflector assembly is provided with a reflector body; the micro-displacement detection device further comprises at least one detector, the at least one detector being disposed on the mounting table and configured to detect displacement of the reflector body.
